(19) United States
(12) Patent Application Publication
(10) Pub. No.: US 2026/0157369 A1
(43) Pub. Date: Jun. 11, 2026

(54) COMPOSITIONS CONTAINING PEROXYACID TO INHIBIT GROWTH OF SPORE-PRODUCING ORGANISMS IN ANIMAL FEED AND RELATED METHODS

(71) Applicant: KEMIN INDUSTRIES, INC., DES MOINES, IA (US)

(72) Inventors: Jatuporn SALAKLANG, Clive, IA (US); Agnes Hwee Hong THNG, Hougang (SG); Haridasan CHIRAKKAL, Herentals (BE)

(73) Assignee: KEMIN INDUSTRIES, INC., DES MOINES, IA (US)

(21) Appl. No.: 19/178,831

(22) Filed: Apr. 14, 2025

Related U.S. Application Data
(60) Provisional application No. 63/633,368, filed on Apr. 12, 2024.

(51) Int. Cl. A01N 37/16; A01N 25/04; A01N 25/22; A01N 25/30; A01N 37/02; A01N 37/04; A01P 3/00

(52) U.S. Cl. CPC A01N 37/16; A01N 25/04; A01N 25/22; A01N 25/30; A01N 37/02; A01N 37/04; A01P 3/00

(57) ABSTRACT

The present invention relates to a food or feed additive that contains one or more peroxyacid in an amount effective to inhibit or control the growth of a spore-producing organism, including but not limited to molds and yeast, particularly under high moisture conditions. Another aspect of the present invention relates to using a composition containing an effective amount of one or more peroxyacid to inhibit or control the growth of mold in an animal's diet. Another aspect of the invention relates to using compositions containing an effective amount of one or more peroxyacids to detoxify mycotoxins. Another aspect of the present invention relates to a kit for treating animal feed to control the growth of spore-producing organisms comprising a peroxypropionic acid concentrate and a buffered solution.

### CROSS-REFERENCE TO RELATED APPLICATIONS

The present application claims the benefit of priority to U.S. Patent Application No. 63/633,368, filed Apr. 12, 2024, entitled “COMPOSITIONS CONTAINING PEROXYACID TO INHIBIT FUNGAL GROWTH IN ANIMAL FEED AND RELATED METHODS,” the entire disclosure of which is incorporated by reference herein in its entirety.

### BACKGROUND OF THE INVENTION

Mold contamination is prevalent in both the food and feed industry, posing a perpetual challenge in this space. Many opportunities for mold contamination exist throughout the animal feed supply chain, including manufacturing processing phases (pre-harvest and post-harvest) and during storage when exposed to temperature and moisture conditions that are optimal for mold growth. Marquardt R. R. (1996), Effects of Molds and Their Toxins on Livestock Performance: A Western Canadian Perspective, Animal Feed Science and Technology, 58(1-2): 77-89; Block, S. S. (1953), Humidity requirements for mold growth, Applied Microbiology, 1(6), 287-293.

It is generally understood that feed contaminated with mold negatively impacts the nutritional value of the animal diet. See, e.g., Block (1953); Bartov I., Paster N., Lisker N. (1982), The Nutritional Value of Moldy Grains for Broiler Chicks, Poultry Science, 61 (11): 2247-54. Paster and Lisker et al. have previously reported that moldy grains adversely affect the nutritional value of feed, resulting in reduced metabolizable energy and depressed performance.

Additionally, mold growth can result in the production of mycotoxins. Mycotoxins are secondary metabolites produced by mold and are highly toxic to animals, causing diseases in both human and livestock. Armendariz C. R. et al. (2014), Mycotoxins, Editor(s): Philips Wexler, Encyclopedia of Toxicology (Third Edition), Academic Press, 424-427. The presence of mycotoxins has been shown to negatively impact the overall supply chain and result in high economic losses across all levels of food and feed production.

Of particular note, aflatoxins are mycotoxins produced by specific Aspergillus mold species, such as Aspergillus flavis and Aspergillus parasiticus, and are known carcinogens. Aflatoxins found in food and animal feed can be mitigated by detoxifying them through various treatments. Current methods of chemical detoxification can reduce the toxicity of the aflatoxins by 200 to 450-fold. Even with existing mitigation methods, the risk of contamination remains a pressing concern, leading to recalls and supply chain disruption.

In view of these supply chain and economic concerns, it is imperative to reduce mold contamination in feed, including through the adoption of measures to minimize the risk of mold contamination. There are commercially available products that offer a comprehensive range of mold inhibition, for instance the MycoCURB® products (Kemin Industries, Des Moines, Iowa), with applications available for feed and raw materials. These products contain a synergistic blend of organic acids, with propionic acid serving as an ingredient. Propionic acid has been widely studied and adopted in the industry as a mold inhibitor. For instance, it has been shown that 1000-2000 ppm of propionic acid is capable of inhibiting Aspergillus niger and Penicillium vericulosum. Higgins et al. reported that complete inhibition can be achieved with propionic acid at a concentration lower than 0.35% when tested against common mold strains such as Aspergillus spp., Penicillium spp, and Fusarium spp. Higgins C., Brinkhaus F. (1999), Efficacy of several organic acids against molds, The Journal of Applied Poultry Research, 8:480-487. The use of propionic acid as a mold inhibitor has been implemented as an industry best practice, with numerous commercial products containing propionic acid available as potential solutions to mold growth.

Given the rising input costs across the agricultural and feed industries, however, there remains a search for alternative solutions that may provide even broader protection against pathogens, for instance serving not only as a mold-inhibitor, but at the same time providing other desirable properties, including the capability to control the growth or spread of bacteria and viruses in known vectors for transmission, for instance in food and feed matrices, or an animal's diet or water supply.

Peracetic acid has been widely studied for its antimicrobial properties. Peracetic acid is commonly used as a disinfectant in various industries due to its wide spectrum of antimicrobial activity. Gehr R., Wagner M., Veerasubramanian P., Payment P. (2003), Disinfection Efficiency of Peracetic Acid, UV and Ozone After Enhanced Primary Treatment of Municipal Wastewater, Water Research, 37(19): 4573-86; Vandekinderen I. et al. (2009), Optimization and Evaluation of a Decontamination Step with Peroxyacetic Acid for Fresh-cut Produce, Food Microbiology, 26(8): 882-888.

However, there has been reluctance to embrace peracetic acid as a solution for controlling the growth of pathogens in vectors for transmission, such as food and feed. For instance, peracetic acid has been found to be associated with the increase of organic content in the effluent, and thus after its initial application, could favor or promote potential microbial regrowth. This significant drawback has limited the potential applications of peracetic acid.

In view of the limitations discussed above, researchers continue to search for a broad-spectrum solution that could serve as a mitigant against spore-producing organisms, for instance a composition that prevents the formation of mycotoxins, that could be added to an animal's diet or water supply or applied to the surfaces that come into contact with an animal's diet or water supply.

### BRIEF SUMMARY OF THE INVENTION

The inventors unexpectedly discovered that despite the drawbacks associated with peracetic acid, compositions containing one or more peroxyacid, such as perpropionic acid (also referred to herein as peroxypropionic acid or PPA) have been shown to be effective as a mold inhibitor or mitigation agent in animal feed. For instance, the inventors have discovered that a composition that contains a blend of acids, specifically PPA in combination with peracetic acid, has been shown to be particularly effective at inhibiting the growth of Salmonella in animal feed and discovered that the composition is also effective for its anti-fungal properties.

The present invention relates to compositions containing peroxyacid to inhibit fungal growth, wherein the compositions are effective at inhibiting or controlling the growth of spore-producing organisms, including but not limited to molds and yeast, particularly under high moisture conditions. Another aspect of the present invention relates to methods using the compositions containing PPA to inhibit or control the growth of spore-producing organisms, where the compositions have been shown to be superior over other solutions, including the use of hydrogen peroxide, propionic acid, acetic acid, and peracetic acid alone, to inhibit the growth of mold strains, for instance A. niger and P. chrysogenum. Another aspect of the invention relates to providing a method of treating animal feed with an anti-fungal additive that is effective in a shorter amount of time compared to conventional methods for treating feed.

### BRIEF DESCRIPTION OF THE FIGURES

FIG. 1 depicts the chemical structure of representative peroxyacids.

FIG. 2A depicts the inhibitory effect of peroxyacids and mixtures against Aspergillus niger ATCC 24126 in comparison to organic acids. The inhibitory effect of the PPA, PAA, and peroxy mix (1:1 PAA:PPA) at 0.7 mol/L or 1.4 mol/L (equivalent to 5% and 10% active propionic acid, respectively, in water/phosphate buffer) was compared using a well diffusion study against mold and using a propionic acid as a positive control.

FIG. 2B depicts the inhibitory effect of peroxyacids and mixtures against Aspergillus niger ATCC 24126 in comparison to organic acids. The inhibitory effect of the PPA, PAA, and peroxy mix (1:1 PAA:PPA) at 0.7 mol/L or 1.4 mol/L (equivalent to 5% and 10% active propionic acid, respectively, in water/phosphate buffer) was compared using a well diffusion study against mold and using a propionic acid as a positive control.

FIG. 2C depicts the efficacy of hydrogen peroxide at different concentrations against mold Aspergillus niger ATCC 24126 strain.

FIG. 2D depicts the inhibitory effect of peroxyacids and mixtures against mold Penicillium chrysogenum Thom ATCC 48908 strain. The inhibitory effect of the PPA, PAA, and peroxy mix (1:1 PAA:PPA) at 0.7 mol/L or 1.4 mol/L (equivalent to 5% and 10% active propionic acid, respectively, in water/phosphate buffer) was compared using a well diffusion study against mold and using a propionic acid as a positive control.

FIG. 2E depicts the inhibitory effect of hydrogen peroxide at different concentrations against mold against Penicillium chrysogenum Thom ATCC 48908 strain.

FIG. 3 depicts the efficacy of peroxyacids against A. niger.

FIG. 4A demonstrates the DRBC plate after 5 days of incubation at 25° C. upon plating for PPA.

FIG. 4B demonstrates the DRBC plate after 5 days of incubation at 25° C. upon plating for peracetic acid.

FIG. 4C DRBC plate after 5 days of incubation at 25° C. upon plating for peroxy mix (MFC=500).

FIG. 4D DRBC plate after 5 days of incubation at 25° C. upon plating for ((D) propionic acid (MFC>2000 ppm).

FIG. 4E DRBC plate after 5 days of incubation at 25° C. upon plating for acetic acid (MFC>5000 ppm).

FIG. 4F DRBC plate after 5 days of incubation at 25° C. upon plating for Propionic acid (MFC>5000 ppm).

FIG. 4G DRBC plate after 5 days of incubation at 25° C. upon plating for Butyric acid (MFC=5000 ppm).

FIG. 5 demonstrates the enumeration of mold in naturally contaminated swine feed.

FIG. 6 depicts mold counts in naturally contaminated swine feed when treated with various compositions.

FIG. 7 depicts chromatographs of aflatoxin treatment with PPA.

FIG. 8 demonstrates the effect of PPA on the area of the aflatoxin chromatograph peak.

### DETAILED SUMMARY OF THE INVENTION

The present invention relates to compositions containing one or more peroxyacid to inhibit fungal growth, for instance in food or feed, where the compositions are effective at inhibiting or controlling the growth of spore-producing organisms, including but not limited to molds and yeast. Another aspect of the present invention relates to methods using compositions containing one or more peroxyacid, for instance PPA, to inhibit or control the growth of spore-producing organisms, where the compositions of the present invention have been shown to be effective an effective mold inhibitor, and superior to other known solutions, including the use of hydrogen peroxide, propionic acid, acetic acid, and peracetic acid, to inhibit the growth of mold strains, such as A. niger and P. chrysogenum, and including but not limited to toxigenic mold commonly found in grains and forage, such as Aspergillus sp., Fusarium sp., Penicillium sp., and for instance common mold strains present in aqua feed, such as Penicillium citrinum and Aspergillus flavus.

Peroxyacids (FIG. 1) are strong oxidizing agents that have been used as disinfecting agents in meat industries and surface cleaning applications of medical instruments due to their ability to denature proteins and disrupt the cell wall membrane of microorganisms. However, to the inventors' knowledge, peroxyacids have not previously been considered as a mitigant for spore-producing organisms, for instance as a feed additive that could be incorporated into animal feed to control the number of spore-producing organisms in the feed.

One reason for the hesitancy around using these compounds could be that peroxyacids react violently when in touch with mild steel or carbon steel, which is predominantly the material of construction of mixer units in feed mills. These mixers are used for blending various micro and macro feed components. Therefore, this poses a serious corrosion risk when the peroxyacid product is sprayed onto the feed ingredients while mixer is in operation. Corrosion of mixer components could result in equipment malfunction and damage, which would be detrimental to the feed mill, or contamination of the feed by metal flakes or metal pieces, which would be detrimental to the feed product. The inventors surprisingly discovered that the integration of peroxyacids by the feed mills did not result in any damage to the feed mill or contamination of the feed product.

Another reason could be that peroxyacids are, by their nature as an oxidizing agent, extremely volatile. This volatility makes these compounds difficult to manage. Shipping, handling, and storage of these compounds has to be carefully considered and requires many safety standards to be in place to prevent excess degradation of the compounds and also to prevent any adverse reactions that could pose a danger to people or property.

PPA solution, for instance where the PPA solution comprises PPA, hydrogen peroxide, propionic acid, and water, was recently reported to be effective against Salmonella in feed applications and could potentially replace the traditional Salmonella mitigants, as described by the inventors in U.S. Application Ser. No. 63/525,315, which is expressly incorporated in its entirety herein. For example, it was reported that a 20% PPA solution demonstrated a comparable Salmonella-killing effect as formaldehyde-based Sal CURB which is commonly regarded as a Salmonella mitigant. Although efficacy of PPA against Salmonella bacteria has been demonstrated, to the inventors' knowledge, this disclosure represents the first-known study of the anti-fungal properties of compositions containing an effective amount of PPA to control the growth of spore-producing organisms, such as mold or yeast.

As used herein, PROSIDUIM™ refers to Kemin Industries' branded product containing PPA. PROSIDUIM™ comprises two components that are mixed on site, prior to application. The two components are PROSIDIUM C and PROSIDIUM S. PROSIDIUM C refers to the PPA concentrate, containing PPA at approximately 15-20%, for instance 16-17%, as well as propionic acid at 40-50%, acetic acid at 5-12% and hydrogen peroxide at 5-10%. PROSIDIUM S refers to the buffer that can be used in combination with the concentrate, containing phosphoric acid and sodium hydroxide. According to at least one embodiment, the components are mixed at a C:S ratio of 9:1.

According to at least one embodiment, the composition is an animal feed additive comprising an effective amount of one or more peroxyacids, for instance a buffered peroxyacid, to control or reduce the presence of mold in animal feed.

According to at least one embodiment, the compositions of the present invention contain an effective amount of PPA to control the growth of spore-producing organisms, such as mold or yeast. In certain embodiments, the compositions contain an effective amount of PPA and at least one organic acid, such as acetic acid, to control the growth of spore-producing organisms, such as mold or yeast. In certain embodiments, the composition further comprises propionic acid.

According to at least one embodiment, the present invention relates to a formaldehyde-free composition suitable for animal feed that is capable of controlling or inhibiting the growth of spore-producing organisms, such as mold and yeast.

According to at least one embodiment, the present invention relates to using the compositions containing one or more peroxyacids in an amount sufficient to reduce any type of spore-producing organism, for instance in an animal's diet, water supply, or containers or surfaces that come into contact with an animal's diet or water supply.

According to at least one embodiment, the present invention relates to using the compositions containing one or more peroxyacids as a fungicide, for instance killing any spore-forming organisms that may be present in an animal's diet, water supply, or containers or surfaces that come into contact with an animal's diet or water supply.

According to at least one embodiment, the present invention relates to using the compositions containing one or more peroxyacids in an amount sufficient to detoxify mycotoxins caused by mold growth.

According to at least one embodiment, the composition further comprises organic peroxides (i.e., perester, peracetic acid, peroctanoic acid) in amounts effective to reduce or control the growth of spore-producing organisms, including but not limited to mold or yeast. In at least one embodiment, the composition is added to the animal's diet or water supply.

According to at least one embodiment, the composition does not contain formaldehyde.

According to at least one embodiment, the composition does not contain formic acid.

According to at least one embodiment, the composition does not contain butyric acid.

According to at least one embodiment, the composition does not contain propionic acid.

According to at least one embodiment, the composition does not contain acetic acid.

According to at least one embodiment, the composition of the present invention optionally contains at least one surfactant.

According to at least one embodiment, the composition of the present invention optionally contains at least one emulsifier. Suitable emulsifiers for this purpose include, but are not limited to, glycerol monooleate, soya lecithin, glycerin monostearate, potassium stearate, calcium stearoyl lactylate (CSL), DATEM, glyceryl monostearate, mono propylene glycol, SPAN 80, sodium stearoyl lactylate (SSL), Tween, sodium stearate, glycerol triacetate, sugar esters, non-dairy creamer, calcium stearate, polyglycerol polyricinoleate (PGPR), lecithin, mono and diglycerides, monoglyceride derivatives, polyglycerol esters (PGE), propylene glycol esters (PGMS), sucrose esters, and sorbitan esters and polysorbates.

According to at least one embodiment, the compositions of the present invention are suitable for adding to animal feed and can be combined with known animal feed ingredients, including but not limited to corn meal, soybean meal, fish meal, soy oil cake, dried distillers' grains with solubles (DDGS), etc.

For purposes of this disclosure, “animal feed” may be provided to the animals or livestock through any convention means well known to persons skilled in the art, include but not limited to top-dress, mixed in by hand, pelleted, mixed with crumbles or granular solids, etc. Animal feed also encompasses high-moisture animal feed as disclosed herein.

According to at least one embodiment, the composition is used to disinfect containers for feed, for example grain bins (storage of dry corn and soybeans), silos (storage of silage, grass or harvested green and wet to feed dairy cattle), storage systems or containers that provide feed or water supply to animals.

According to at least one embodiment, the composition is a dry ingredient. For instance, in at least one embodiment, the composition is a feed additive that is incorporated into the animal feed at the feed mill.

According to at least one embodiment, the composition is a wet ingredient. For instance, in at least one embodiment, the composition is a feed additive that is capable of being sprayed onto the feed. In at least one embodiment, the composition is applied to the animal feed using a liquid applicator.

According to at least one embodiment, the composition is composed of a first component and a second component. In at least one embodiment, the first component comprises at least one peroxyacid, for instance a concentrate, and the second component comprises a buffer.

When combined, the first component and the second component create a buffered solution with a pH in the range of <1 to 0, for example pH 1-4, or more specifically 2-3. In at least one embodiment, the first component has a pH of less than 2, for instance less than about 1, and the second component has a pH in the range of about 12 to 14, for instance about 12 to 13. In at least one embodiment, the components are mixed on site to form the composition prior to application.

According to at least one embodiment, the composition is composed of a first component and a second component. In at least one embodiment, the first component comprises at least one peroxyacid and the second component comprises a buffer. In at least one embodiment, the first component has a pH less than 1 and the second component has a pH in the range of 12-13. In at least one embodiment, the components are mixed on site to form the composition prior to application.

According to at least one embodiment, the first component and the second component are combined in a ratio ranging from 4:1 to about 12:1, for instance about 7:1, 8:1, 9:1, 10:1, 11:1 or 12:1. In at least one embodiment, the first component and the second component are combined in a ratio of about 9:1.

According to at least one embodiment, the present invention relates to methods of treating animal feed with a mitigant for mold, wherein the feed can be treated within a shorter treatment time compared to conventional methods for mitigating against the spread of mold. For instance, in at least one embodiment, the treatment time is one hour or less. In certain embodiments, the treatment time is about one hour or less, about 30 minutes or less, about 20 minutes or less, about 10 minutes or less, or about 5 minutes or less. In certain embodiments, compositions of the present invention are capable of killing mold in one hour or less.

According to certain embodiments, the composition contains one or more peroxyacids. In alternative embodiments, the composition contains two or more peroxyacids, including PPA. In alternative embodiments, the composition contains PPA (plus buffer), with efficacy that is superior to other organic peroxides, such as treatments with peracetic or percarbonate alone.

In at least one embodiment, the composition of the present invention provides desirable characteristics to the animal's diet when used as a food or feed additive, such as providing a prolonged or extended shelf-life of the food or feed, where the inhibition of spore-growth assists in providing a longer shelf-life for the treated product, such as food or feed, compared to an untreated product (i.e., a product that has not been treated with compositions of the present invention).

### EXAMPLES

### Example 1: Fungicidal Effects of Peroxyacids

### Materials and Methods

Preparation of mold suspension. Aspergillus niger ATCC 24126 and Penicillium chrysogenum Thom ATCC 48908 were purchased from American Type Culture Collection (ATCC). The strains were stored at −80° C. in glycerol. Prior to test, both strains were revived by streaking a loopful of culture onto DRBC (i.e., dichloran rose-bengal chloramphenicol (CM1148B; Thermo Scientific Oxoid) prepared as per recommended by supplier) with 72 hours incubation at 25° C. The three-days old mold culture lawn was diluted in phosphate buffer (0.30 mM; pH 7.2) to obtain a mold suspension of ca. 10⁶ CFU/mL. The colony count of the suspension was determined through conventional plating method using DRBC agar at the appropriate dilution. Briefly, the mold suspension was diluted to the appropriate dilution with phosphate buffer (0.30 mM; pH 7.2). Upon dilution, 100 μL of the diluted mold suspension was spread onto the DRBC agar. After which, the plates were incubated at 25° C. for five days prior to counting. Tests were carried out in triplicates.

Preparation of test solutions for well diffusion assay. Propionic acid and acetic acid were used without further purification or mixing. PPA and peracetic acids were synthesized using organic acid and 50% w/w hydrogen peroxide at the molar ratio of 1:1 and an acid catalyst, arriving at the composition summarized in Table 1. The peroxy mixture was prepared with equivalent amount of peracetic acid and PPA, with 1.0 g of peroxy mixture prepared by weighing 0.5 g of peracetic acid into 0.5 g of PPA. The mixture was then mixed well using vortex prior to usage. Hydrogen peroxide of 3% w/w in water was further diluted in water prior to usage. To achieve 0.30% of hydrogen peroxide for assay, 100 μL of 3% w/w hydrogen peroxide is diluted in 950 μL of water to achieve a final volume of 1000 μL. Similar procedure with variation in dilution volumes was performed for other hydrogen peroxide concentrations (i.e., 0.3, 0.6 and 1.0%).

TABLE 1
Compositions of peracetic acid and PPA

Composition (%)

| Peroxy acid | Hydrogen peroxide | Peroxy acid |
|---|---|---|
| Peracetic acid | 11.2 | 20.1 |
| PPA | 9.4 | 21.5 |

Well diffusion assay. To prepare the mold lawn for well diffusion assay, 200 μL of the mold suspension was pipetted onto the pre-prepared DRBC agar (i.e., 80 mL of agar solution in 140×20 mm petri dish) and spread evenly with a moist cotton swab. Following which 100 μL of the test solution (i.e., propionic acid, acetic acid, hydrogen peroxide, PPA, peracetic acid and peroxy mix) were added into the well, perforated with a sterile glass pipette, at tested concentration prepared in sterile water. Peroxy mix, peroxypropionic, peroxyacetic, propionic acid and acetic acid were tested at 0.175 and 0.350 mol/L. The corresponding hydrogen peroxide present in 0.175 and 0.350 mol/L of peroxy acid are approximately 0.4% and 0.8%. Thus, hydrogen peroxide was tested in the range of 0.3-1.0%. Sterile water was included as control. The plates were incubated at 25° C. with zone of inhibition measured after 72 hours. Tests were conducted in triplicates.

Fungicidal effect of PPA against A. niger. The fungicidal effect of PPA in solution was evaluated in comparison to propionic acid and hydrogen peroxide. To serve as a positive control and comparison point, propionic acid, was tested at two concentrations, 1500 and 3000 ppm, equivalent to 0.02 and 0.04 mol/L. On the other hand, PPA was tested at a single concentration of 0.02 mol/L. To evaluate the effect of hydrogen peroxide, hydrogen peroxide was also included as one of the treatment groups. Hydrogen peroxide was tested at 2.43% w/w. The concentration of hydrogen peroxide to be tested is calculated based on the equivalent amount present in 0.02 mol/L of PPA, which is the sum of hydrogen peroxide already present and from the potential breakdown of PPA. A 900 μL of mold suspension (of c.a. 10⁶ CFU/mL prepared in 0.9% sodium chloride) was treated with 100 μL of the test solutions (prepared in sterile water) for one hour.

After one hour, the treatment solutions were neutralized with 2 mL of sodium thiosulphate and 7 mL of phosphate buffer (0.3 mM; pH 7.2). The solution was at 10-1 dilution. Subsequently the solution was further diluted up to 10-5 with phosphate buffer. The mold count for each treatment was determined through conventional plating method using DRBC agar. Test was conducted in triplicates. Controls were prepared with i) 100 μL of sterile water instead of test solutions and ii) 900 μL of 0.9% sodium chlorine instead of mold suspension and 100 μL of sterile water instead of test solutions.

### Results

Colony count for the mold suspensions. Table 2 tabulates the colony count for the mold suspension prepared for both A. niger and P. chrysogenum. The mold suspensions used for preparation of well diffusion assay were 6.34 and 6.53 log CFU/mL for A. niger and P. chrysogenum respectively.

TABLE 2
Average mold count (n = 3) for the mold
suspension prepared for well-diffusion assay

| | Mold count |
|---|---|
| Mold strain | (log CFU/mL) |
| Aspergillus niger ATCC 24126 | 6.34 ± 0.15 |
| Penicillium chrysogenum Thom | 6.53 ± 0.06 |
| ATCC 48908 | |

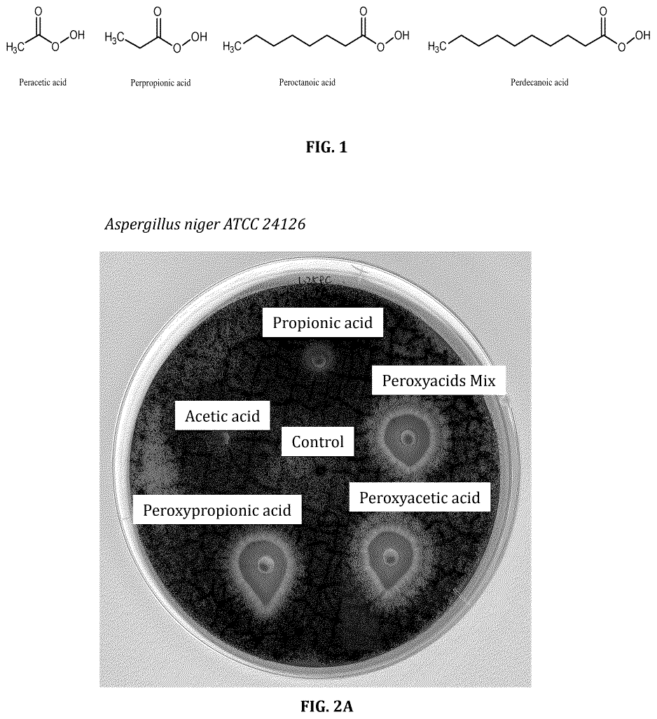

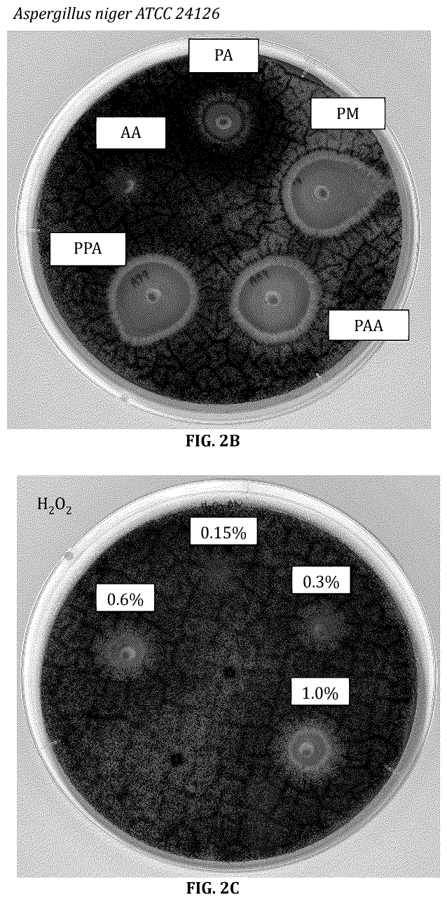

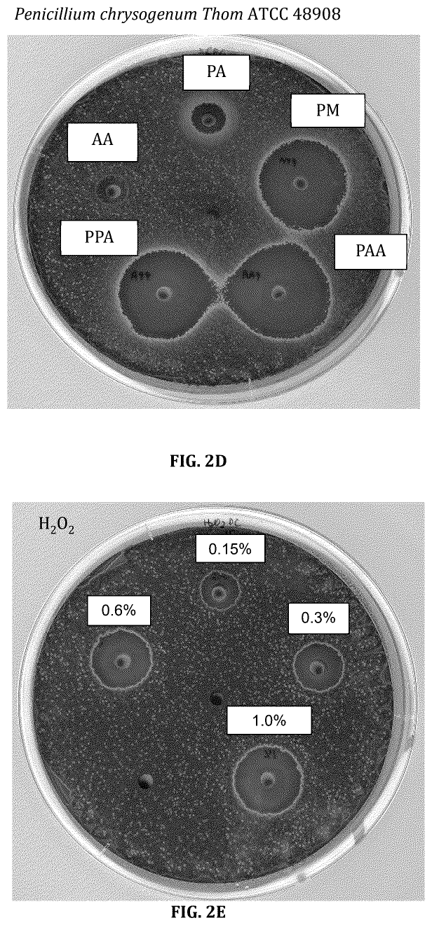

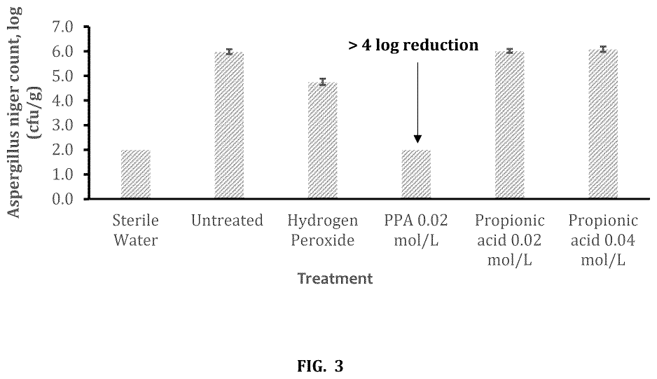

Mold inhibitory effect of peroxy acids. Average zone of inhibition measured were tabulated in Table 3. Peroxy acids are more efficacious in inhibiting both A. niger and P. chrysogenum in comparison to equimolar of propionic and acetic acids. Additionally, peroxy acids outperformed the inhibitory effect of hydrogen peroxide. The corresponding hydrogen peroxide present in 0.175 and 0.350 mol/L of peroxy acid are approximately 0.4% and 0.8%. A smaller zone of inhibition (p<0.05) was observed with hydrogen peroxide, up to 1.0%, in comparison to the three peroxy acid treatment groups at both concentrations (0.175 and 0.350 mol/L) against A. niger. However, no significant difference (p>0.05) was observed between peroxy acids at 0.175 mol/L and hydrogen peroxide at 0.6 and 1.0% when tested against P. chrysogenum. Comparatively, the zone of inhibition measured for the peroxy acids were close. No statistical differences were observed between the three peroxy acid treatment groups (p>0.05). This indicates that the antifungal effects of the peroxy acid were comparable and that there is no added effect with the combination of peroxy acids (peracetic acid and PPA). Interestingly, as summarized in FIG. 2 and Table 3, the results showed that P. chrysogenum is more susceptible to the treatments in comparison to A. niger where generally a larger zone of inhibition was observed with P. chrysogenum with the same treatment.

TABLE 3
Average zone of inhibition measured (n =
3) for each treatment after incubation for 72 hours

| | | Zone of inhibition, Average ± | |
|---|---|---|---|
| | | standard deviation (mm) | |
| | | | Penicillium |
| | Active | Aspergillus | chrysogenum |
| | concentration^{#} | niger ATCC | Thom ATCC |
| Treatment | (mol/L) | 24126 | 48908 |
| Diluent | — | ND^{a} | ND^{a} |
| Propionic acid | 0.350 | 12.12 ± 0.03^{c} | 12.12 ± 0.43^{bc} |
| Propionic acid | 0.175 | 9.42 ± 0.66^{bc} | 9.15 ± 0.45^{b} |
| Acetic acid | 0.350 | ND^{a} | 10.87 ± 0.75^{b} |
| Acetic acid | 0.175 | ND^{a} | 8.97 ± 0.55^{b} |
| PPA* | 0.350 | 25.67 ± 2.05^{e} | 35.45 ± 4.55^{g} |
| PPA* | 0.175 | 16.42 ± 2.19^{d} | 23.80 ± 0.58^{ef} |
| Peracetic acid* | 0.350 | 24.67 ± 2.04^{e} | 36.00 ± 3.80^{g} |
| Peracetic acid* | 0.175 | 16.03 ± 0.80^{d} | 24.05 ± 0.33^{ef} |
| Peroxy mix* | 0.350 | 26.90 ± 2.26^{e} | 31.18 ± 1.73^{g} |
| Peroxy mix* | 0.175 | 16.87 ± 0.72^{d} | 24.47 ± 0.06^{f} |
| Hydrogen peroxide | 1.0% v/v | 10.93 ± 0.31^{bc} | 22.08 ± 0.34d^{ef} |
| Hydrogen peroxide | 0.6% v/v | 9.42 ± 0.16^{bc} | 19.32 ± 0.76^{de} |
| Hydrogen peroxide | 0.3% v/v | 8.00 ± 0.00^{b} | 17.10 ± 0.05^{cd} |

ND = Not detected.
^{#}Concentrations are expressed in mmol/L unless stated otherwise in the table.
*Amount of peroxy acid used is based on the equivalent amount of propionic/acetic acid.
Superscript alphabetical letters in the same column indicate significant differences (p < 0.05).

Fungicidal effect of PPA. Consistent to the results from well diffusion assay (FIG. 3), PPA demonstrated strong fungicidal effect where at least 4 log CFU/mL reduction of A. niger was observed with 0.02 mol/L of PPA (Table 4). In contrast, no count reduction was observed with propionic acid at the same molar concentration. Two concentrations were tested with propionic acid at 0.02 and 0.04 mol/L, corresponding to 1500 and 3000 ppm respectively. Similarly, no fungicidal effect was observed with propionic acid concentration at 0.04 mol/L. Fungicidal effect was observed with hydrogen peroxide at the corresponding concentration present (at 2.43%) in the peroxy acids where A. niger count was reduced by approximately 1.2 log CFU/mL. Although the count reduction was significantly lower (p<0.05) than with PPA, this demonstrated that hydrogen peroxide present may have also contributed to the antifungal effect observed in PPA.

TABLE 4
Average A. niger count (n = 3) observed for each treatment group

| | | A. niger count, |
|---|---|---|
| | | Average ± |
| | Concentration^{#} | standard deviation |
| Treatment | (mol/L) | (log CFU/mL) |
| Sterile water | — | <100^{a} |
| Negative control | — | 5.98 ± 0.10^{c} |
| PPA | 0.02 | <100^{a} |
| Hydrogen peroxide | 2.43% v/v | 4.75 ± 0.13^{b} |
| Propionic acid | 0.02 | 6.01 ± 0.08^{c} |
| Propionic acid | 0.04 | 6.08 ± 0.11^{c} |

^{#}Concentrations are expressed in mol/L unless stated otherwise in the table.
*Amount of peroxy acid used is based on the equivalent amount of propionic/acetic acid used in the synthesis.
Superscript alphabetical letters in the same column indicate significant differences (p < 0.05)

### Discussion

The efficacy of peroxy acids (perpropionic and peracetic acids) was compared against the corresponding starting materials (propionic and acetic acids) at equimolar amount against A. niger and P. chrysogenum. Hydrogen peroxide was also included at an equivalent concentration present in the peroxy acid to evaluate its antifungal effect.

The screening study was conducted with well diffusion assay and revealed the strong mold inhibitory effect of peroxy acid at both 0.175 and 0.350 mol/L (Table 3). There was a comparatively smaller zone of inhibition observed with the corresponding starting materials (propionic acid and acetic acid) and hydrogen peroxide at equivalent molar concentration or percentage. Results from well diffusion assay have shown that comparable inhibitory effect was observed with the different individual peroxy acids (peracetic and propionic acids in phosphate buffer) and combinations (peroxy mix containing 1:1 w/w peracetic acid and PPA with phosphate buffer (pH 7)) where zone of inhibition measured were close (p>0.05). Interestingly, the results showed that A. niger demonstrated higher resistance towards the treatment group. Given these observations, the researchers next considered the fungicidal effect of PPA against a chemical resistance mold strain, A. niger.

The fungicidal effect of PPA (in phosphate buffer, pH 7) was tested in comparison to the corresponding equimolar amount of propionic acid and the equivalent concentration of hydrogen peroxide present. PPA exhibited effective fungicidal effect at 0.02 mol/L (Table 4). In comparison to propionic acid, negligible fungicidal effect was observed up to twice higher concentration (0.04 mol/L). This is possibly due to the differences in the mode of action. It is well known that organic acid works by entering the cells in its undissociated form and dissociates within the cell. Such dissociation could cripple the cellular activities, eventually leading to cell death. However, the accumulation of organic acids is required to achieve this effect; thus, treatment time and active concentration are crucial to observe the fungicidal effect.

### Example 2. Minimum Fungicidal Effect (MFC) of PPA in Comparison to Other Organic Acids

### Materials and Methods

Preparation of mold solution. Aspergillus niger isolate was cultured onto a potato dextrose agar (PDA, prepared as per supplier's recommendation) from its glycerol stock at 25° C. for 72 hours. After 72 hours incubation, the mold spores were picked up using moistened cotton swab. A sterile cotton swab was moistened with 0.1% peptone water and swabbed across the 3-day old PDA plate grown with A. niger. The cotton swab with the mold spores is then dipped into 10 mL of 0.1% peptone water to create a ca. 10⁵⁻⁶ CFU/mL of mold solution. The mold level in the solution was determined via conventional plating method. The mold solution is serially diluted with 0.1% peptone solution and plated onto dichloran rose-bengal chloramphenicol (DRBC, prepared as per supplier's recommendation) agar. The agar was then subsequently incubated at 25° C. for 5 days prior to counting.

Minimum fungicidal concentration (MFC). Peroxy acid and propionic acid treatments was prepared at 4000 ppm in 0.1% peptone solution and serial diluted two-folds in a 96 well plates. Each well should contain 100 μL of treatment solution. Subsequently, a 100 μL of mold solution (ca. 10⁵⁻⁶ CFU/mL) was added into the 96-well plate, already containing the treatment solutions. The concentration tested 2000, 1000, 500, 250, 125, 62.5 and 31.25 ppm. After the addition of the mold solution, the plate was incubated at 25° C. for 48 hours. After incubation, 100 μL of the suspension in each well was plated onto a DRBC agar to observe for any mold growth. MFC is determined as the minimum concentration required where no visible mold growth was observed after 5 days of incubation at 25° C. from plating. A 100 μL of 0.1% peptone solution with 100 μL of mold solution and a 200 μL of 0.1% peptone solution were used as a control and blank respectively. Treatments, control and blank were all carried out in triplicates.

### Results

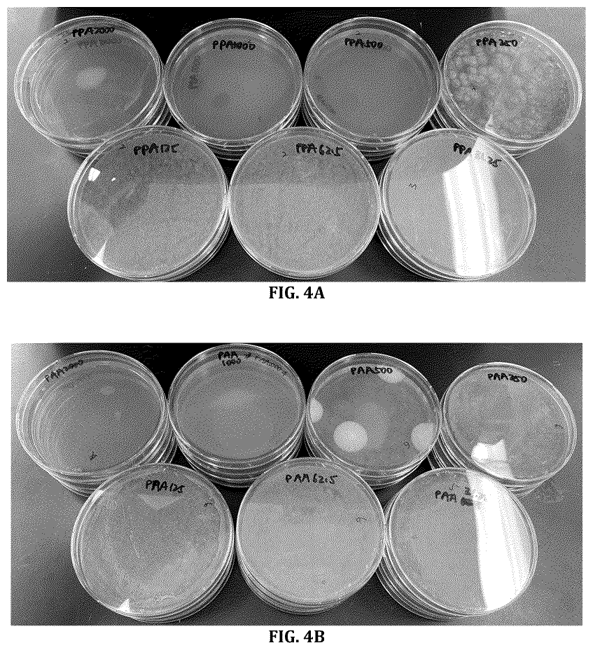

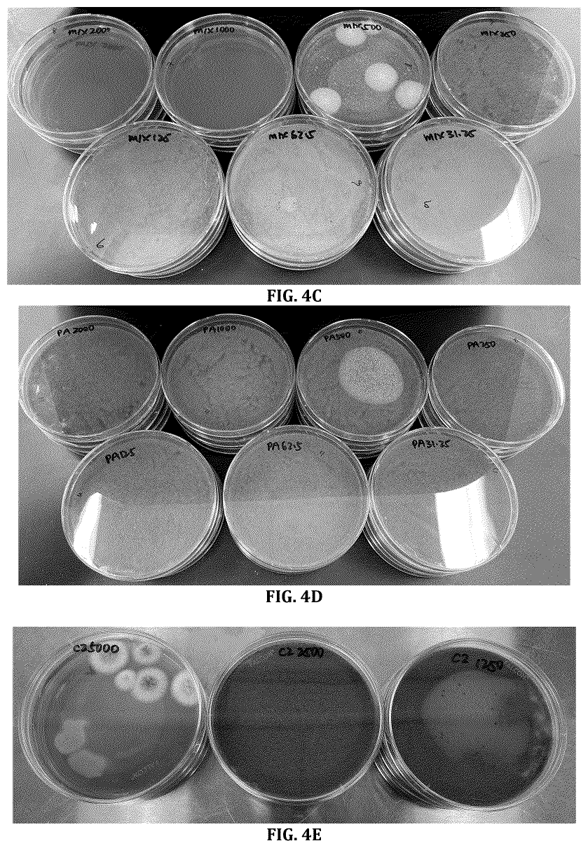

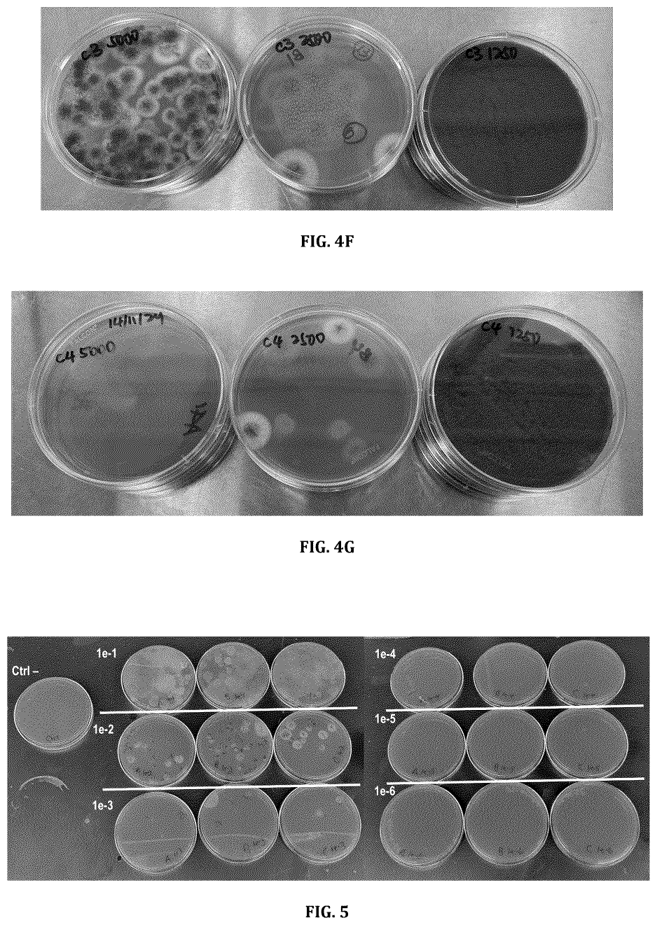

The assay was carried out with Aspergillus niger isolate. The results of the minimum fungicidal concentrations study showed that all peroxy treatments were more effective than the commonly used mold mitigant, propionic acid (Table 5). Furthermore, the MFC data showed that PPA is the most efficacious in the killing effect, followed by peracetic acid or a peroxyacid mixture of PPA and PAA. The MFC data of propionic acid (at the same acid equivalent to peroxyacid product) has an MFC value >5000 ppm compared to PPA at 500 ppm. Further, the MFC study showed that PPA is potentially at least 5 times more effective in killing mold than propionic acid (see FIG. 4).

TABLE 5
Minimum fungicidal concentrations (MFC) for different treatments.

| Treatment | Minimum fungicidal concentration (ppm) |
|---|---|
| PPA¹ | 500 |
| Peracetic acid² | 1000 |
| Peroxy mix³ | 1000 |
| Propionic acid⁴ | >5000 |

¹PPA solution contains 16.8% PPA and 6.8% hydrogen peroxide.
²Peracetic acid solution contains 16.8% peracetic acid and 6.6% hydrogen peroxide.
³Peroxy mix contains 1:1 w/w PPA and peracetic acid.
⁴Propionic acid at 99.5-100.5% purity.

### Example 3. Efficacy of PPA in Naturally Contaminated Feed

### Materials and Methods

A corn and soybean meal-based swine feed (Des Moines Feed, Des Moines, IA) was used to evaluate peroxy acid efficacy in naturally contaminated feed. The feed was ground and passed through a size 12 mesh. Treatments included (1) propionic acid (60% P0500 TCI) and (2) PPA (containing 16% PPA, 6% hydrogen peroxide) with sodium phosphate buffer (Buffer S). The treatments were prepared at concentrations that allowed the same volume of liquid (1 ml) to be applied for each of the treatments (Table 6). ASTM Type II water was used to dilute the applied treatments and for the negative control (Ctrl-). For each treatment, 50 g of feed received two applications of 0.5 mL with a Hamilton 0.5 ml syringe. The feed was mixed for 1 minute after each 0.5 ml treatment application. Treated feed was incubated at room temperature for 24 hours before analysis.

TABLE 6
Calculations for the dosing of the treatments
applied to 50 g of swine feed.

| Dose | | | |
|---|---|---|---|
| g/MT | Product in grams/ | mg (PPA + Buffer)/ | mg (60% propionic |
| feed | kg of feed | 50 g feed | acid)/50 g feed |
| 500 | 0.5 | 25 | — |
| 1000 | 1 | 50 | — |
| 5000 | 5 | 250 | 250 |

Triplicate 5 g feed samples from each treatment were taken and tested for molds. Each sample was mixed vigorously with 45 mL Butterfield's Phosphate Buffer for 30 s, then pour plated at 10-1 and 10-2 dilutions, and covered with 20 mL of tempered DRBC agar. Plates were allowed to solidify and then were incubated upright in a 25° C. incubator for 5 days. Plates with 15 to 150 colonies were counted. Plates with greater than 150 colonies were designated as too numerous to count.

### Results

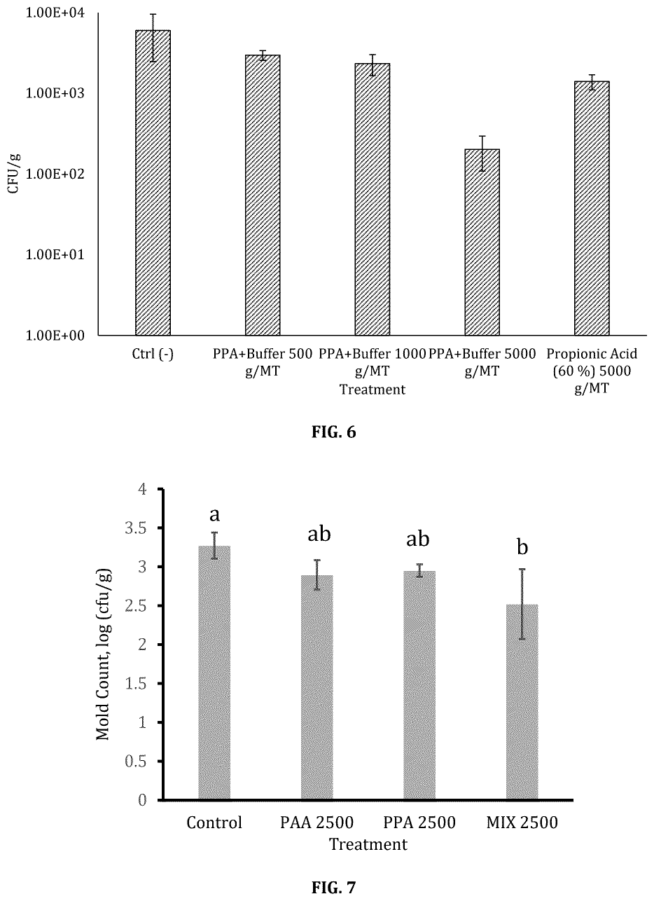

Untreated feed was observed to have an average of 6×10⁴ CFU/g (FIG. 5). The application of PPA+Buffer to the feed caused a decrease in mold counts in a dose-dependent manner. Applying 5000 g/MT of PPA+Buffer decreased the counts by 1.24 log CFU/g. The 5000 g/MT of PPA+Buffer treatment was the only feed treatment where the plates of the 10⁻¹ dilutions had less than 150 mold colonies. The PPA+Buffer treatment was more efficacious than the 60% propionic acid treatment. The reduction in mold caused by the 60% propionic acid control treatment at 5000 g/MT was similar to the mold reduction caused by 1000 g/MT PPA treatment (FIG. 6), which confirms the high potential of the PPA as a new effective solution for antifungal or as a new environmentally friendly fungicide.

### Example 4. Inhibition of Mold Growth on Naturally Contaminated Feed by Peroxyacids

### Materials and Methods

PPA acid and peracetic acid stock solutions were provided at a concentration of 20% peroxyacid. The treatment solutions were diluted to the correct concentration with ASTM Type II water before application of the treatments. Feed for laying hens that is naturally contaminated with mold was used for the study. The initial mold count of the feed was log 4.66 cfu/g. For each treatment, 100 g of feed was treated with 1.5 ml of the diluted PPA, peracetic acid or a 1:1 mix of PPA acid and peracetic acid, resulting in a final concentration of 2500 ppm of peroxyacid on the feed. The negative control treatment was treated with 1.5 ml of water. The feed was kept for 7 days at 25° C. before analysis.

Triplicate 5 g feed samples from each treatment were taken and tested for molds. Each sample was mixed vigorously with 0.1% peptone water 30 s and then a 0.1 ml aliquot of the sample was plated on DRBC agar and incubated upright in a 25° C. incubator for 5 days before counting.

### Results

The application of the peroxyacids to feed caused a decrease in mold counts seven days after treatment (FIG. 7). Treating the feed at 2500 ppm of PPA or peracetic acid decreased the mold growth, but the counts were not significantly different from the control treatment. However, treatment of a combined 1250 ppm PPA and 1250 ppm peracetic acid decreased the mold counts to a level that is significantly different from the negative control. The mixture of PPA and peracetic acid act synergistically to inhibit the growth of mold on naturally contaminated feed.

### Example 5. Efficacy of Peroxypropionic Acid (PPA), Peroxypropionic Acid (PPA) Mixed with Peroxyacetic Acid (PAA) Mixture, and Propionic Acid-Based Product in Naturally Contaminated Feed

### Materials and Methods

Layer feed was used for this study and found to be naturally contaminated with approximately 4 log (CFU/g) of mold. The contaminated level in feed was confirmed using DRBC agar and 0.1% peptone water as diluent. The feed moisture level was 12.3% and a water activity of 0.66.

### Treatment Groups:

1. Peroxypropionic acid (PPA) at 2.5 kg/ton (at 20% purity)
2. PPA and Peroxyacetic acid (PAA) in 1:1 ratio (MIX) at 2.5 kg/ton
3. Myco CURB Liquid (MCL) 2.5 kg/ton. MCL is an existing effective mold inhibitor product, containing propionic acid (60-70%), surfactant, and water as the main ingredients.

Procedure: The appropriate amount of each composition (PPA, MIX, and MCL) was weighed and adjusted to a total volume of 7.5 mL. For treatment, the compositions were each added to 500 g of feed using a syringe and needle. The contaminated feed was monitored over 7 post-treatment days using DRBC agar and 0.1% peptone water as diluent. These treatments were also used for a carbon dioxide (CO2) production test. The test was carried out using a 500 mL Duran flask containing the treatment sample with feed equipped with a Guardian CO2 detector to observe the rate of carbon dioxide production in the headspace over time to draw a correlation to the anti-fungal activity of the products/molecules. After applying the compositions to the feed, the relative CO2 production was then monitored for 75 days. To ensure that the moisture level of the untreated feed (control) was the same as those of treated feeds, 7.5 mL of sterile water was added to the control. Subsequently, the feed was collected in a 500 mL Duran bottle and tightly capped with its designated caps for carbon dioxide measurement over time. All samples were stored at 25° C. Tests were carried out in triplicates.

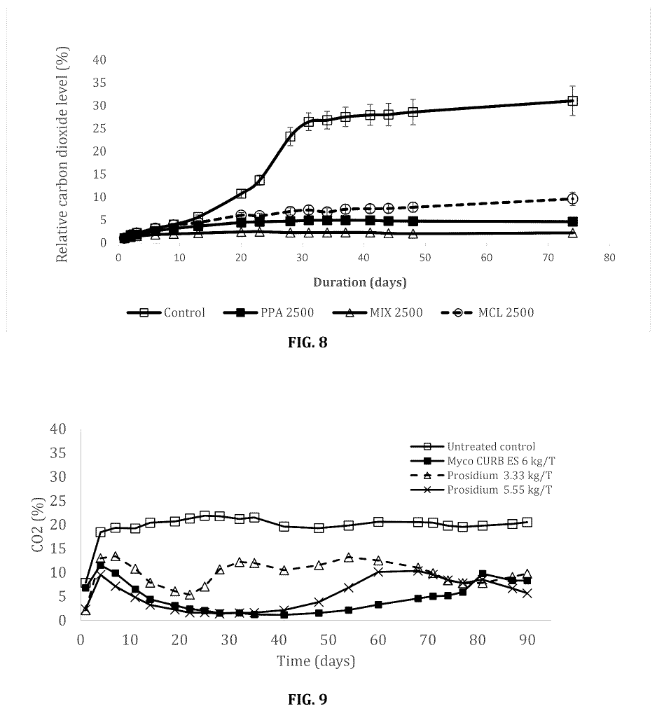

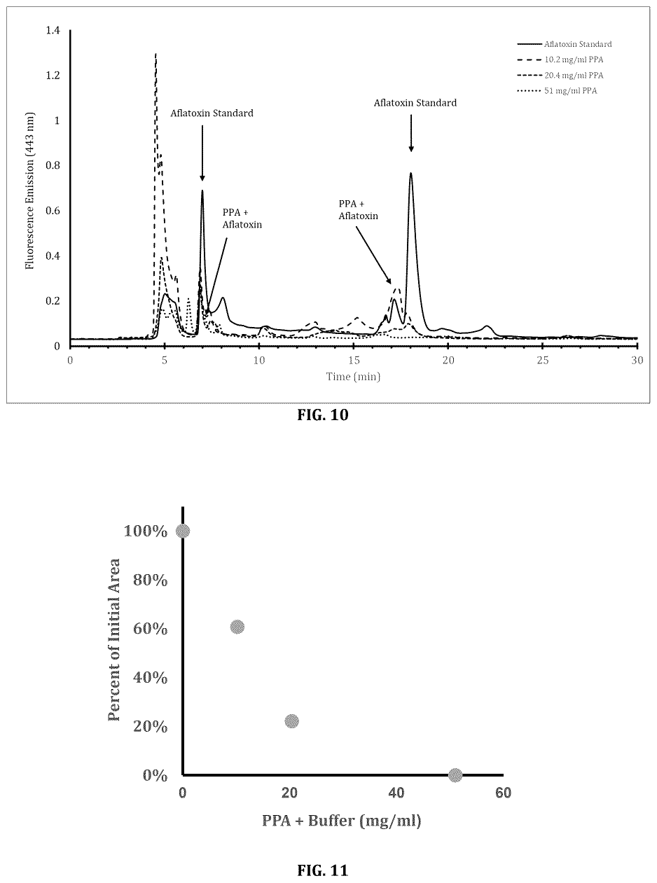

Results: As shown in FIG. 8, the results showed that treatment with peroxyacid MIX (PPA mixed with PAA) and PPA at 2500 g/T could inhibit mold growth, as measured by CO2 level, to be below 10% relative CO2 for at least 75 days of storage. A common mold inhibitor, MCL, showed lower performance on mold inhibition after 75 days. This study, combined with the previous observation on the killing effect study, shows that peroxyacid products have greater potential for killing mold and inhibiting mold growth over a longer period of feed storage compared to the existing mold inhibitor and the controlled feed.

### Example 6. Efficacy of PPA Acid as a Mold Inhibitor for Grain Under a High Moisture Condition

### Materials and Methods

Products. Barley was procured from a local supplier in Belgium (Van Hool Maalderij, Grobbendonk). Treatments included PROSIDIUM and Myco CURB ES Liquid, while untreated samples were used as a control. Myco CURB ES contains 60-65% propionic acid as a main composition and ˜35-40% water, phosphoric acid, sorbic acid, ammonia, and surfactant.

Efficacy. The moisture level of the barley samples was adjusted to a high-moisture condition, 20.1+/−0.5% by adding tap water. The high-moisture barley samples, with the adjusted moisture content, were afterwards treated with PROSIDIUM at different dose levels (3.33 Kg/T and 5.55 Kg/T) or Myco CURB ES Liquid at 6 Kg/T. All barley samples were stored at 25° C. in closed plastic containers to evaluate the CO2-production. The CO2 production in the headspace was monitored regularly for 3 months using the Edinburgh sensor Guardian NG. Three replicates were analyzed for each treatment.

### Results

Mold levels in the high-moisture barley samples as a function of time, measured by CO2 production of the samples, are depicted in FIG. 9. The data generated during the CO2 monitoring study of the barley samples showed a clear difference between the untreated sample and samples treated with PROSIDIUM at 3.33 Kg/T and 5.55 Kg/T and Myco CURB ES Liquid at 6 Kg/T. A very fast increase in CO2 levels was measured in all samples within the first days. In the untreated samples, the CO2 level stayed around 20% during the whole course of the trial. In the samples treated with PROSIDIUM and Myco CURB ES, CO2 levels decreased again after a few days. The CO2 production was statistically significantly lower (P<0.05) for all treated samples, and the % CO2 level was well below 12% for all treated samples compared to the untreated control, indicating the potential benefits of a product containing PPA in the formulation as mold inhibition for grains at high moisture levels.

### Example 7. Oxidation of Aflatoxin by PPA with Buffer

### Materials and Methods

Aflatoxin standard (containing a cocktail of aflatoxins) was purchased from Neogen, and PPA (17%) was diluted 9:1 in sodium phosphate buffer (Buffer S). The PPA reactions were performed by adding 5 μl, 10 μl, or 20 μl of PPA solution to 50 μl of Aflatoxin standard. The reactions were incubated for 16 hours at room temperature; then, sodium phosphate buffer was added to bring the volume up to 75 μl. The samples were then incubated for 7 hours before analysis.

The residual aflatoxin content was quantified using high-performance liquid chromatography. As the aflatoxin is detoxified, it changes the chemical structure of the molecule, which can change the fluorescence properties of the molecule. This makes it possible to follow the degradation of Aflatoxin by measuring the area of the Aflatoxin fluorescence peak by HPLC. An Agilent 1200 HPLC equipped with a C18 reverse-phase analytical column (Phenomenex Luna C18, 250 mm×4.6 mm i.d., 5 μm particle size) was used for the separation. The mobile phase was 30% acetonitrile and 70% water, at a flow rate of 1 ml/min. The sample injection volume was 10 μl. Aflatoxin fluorescence was measured using an excitation wavelength of 333 nm and an emission wavelength of 443 nm.

### Results

The fluorescence emission from aflatoxin molecules can be used to detect aflatoxins selectively. High-performance liquid chromatography with fluorescence detection was used to measure the degradation of aflatoxin by PPA; the aflatoxin peak was detected at 17.5 min (FIG. 10). Exposing aflatoxin to PPA decreases the area of the aflatoxin peak. As the aflatoxin is exposed to higher concentrations of PPA, the area of the aflatoxin peak is found to decrease in a dose-dependent manner (FIG. 11). These data demonstrate that PPA reacts with aflatoxin, which changes the structure and can lead to a less toxic aflatoxin molecule. PPA can detoxify mold toxins as well as inhibit the growth of the molds that produce the toxins.

To the best of the inventors' knowledge, this is the first study to assess the efficacy of peroxy acid under neutralization (higher pH) as an antifungal or mold inhibitor. The work unexpectedly demonstrated the strong fungicidal effect of peroxy acids in phosphate buffer, in particular the efficacy of PPA in comparison to its corresponding starting materials. Further still, it was observed that the antifungal efficacy can be achieved in a shorter amount of time (e.g., less than one hour) compared to the time required in conventional methods. In certain embodiments, the effect occurs rapidly and in even shorter amounts of time, such as 30 minutes, 20 minutes, 10 minutes, or less. As used herein, “high moisture” refers to grain or silage that exceed industry recommendations, such as 11.5% or greater.

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

It should be further appreciated that minor dosage and formulation modifications of the composition and the ranges expressed herein may be made and still come within the scope and spirit of the present invention.

The foregoing description has been presented for the purposes of illustration and description. It is not intended to be an exhaustive list or limit the invention to the precise forms disclosed. It is contemplated that other alternative processes and methods obvious to those skilled in the art are considered included in the invention. The description is merely examples of embodiments. It is understood that any other modifications, substitutions, and/or additions may be made, which are within the intended spirit and scope of the disclosure. From the foregoing, it can be seen that the exemplary aspects of the disclosure accomplish at least all of the intended objectives.

1. A method of controlling growth or spread of a spore-producing organism on a surface, comprising applying to the surface a composition comprising one or more peroxyacid in an amount effective to reduce a number of the spore-producing organism on the surface compared to an untreated surface.

2. The method of claim 1, wherein the spore-producing organism is mold or yeast.

3. The method of claim 1, wherein the one or more peroxyacid is peroxypropionic acid.

4. The method of claim 1, where the composition further comprises an acid selected from the group consisting of acetic acid, citric acid, propionic acid, and blends thereof.

5. The method of claim 1, wherein the composition further comprises a peroxide.

6. The method of claim 1, wherein the surface exists on animal feed.

7. The method of claim 1, wherein the surface is part of a storage system for animal feed.

8. The method of claim 1, wherein the surface is part of a grain bin.

9. The method of claim 1, wherein the surface is part of a silo.

10. The method of claim 1, where the surface is part of storage system to supply water to animals.

11. The method of claim 1, wherein the surface is part of a container that comes into contact with animal feed or water.

12. A method of controlling growth or spread of a spore-producing organism in a granular solid, comprising applying to the granular solid a composition comprising one or more peroxyacid in an amount effective to reduce a number of the spore-producing organism on the granular solid compared to an untreated granular solid.

13. The method of claim 12, wherein the spore-producing organism is mold or yeast.

14. The method of claim 12, wherein the one or more peroxyacid is peroxypropionic acid.

15. The method of claim 12, where the composition further comprises an acid selected from the group consisting of acetic acid, citric acid, propionic acid, and blends thereof.

16. The method of claim 12, wherein the granular solid is animal feed.

17. A method of controlling growth or spread of a spore-producing organism in animal feed, comprising:
applying to the animal feed a composition comprising one or more peroxyacid;
wherein the composition contains an effective amount of the one or more peroxyacid to reduce a number of the spore-producing organism in the animal feed compared to an untreated animal feed.

18. The method of claim 17, wherein the spore-producing organism is mold or yeast.

19. The method of claim 17, wherein the animal feed susceptible to the spore-producing organism has a high-moisture content.

20. The method of claim 17, wherein the animal feed comprises one or more of corn meal, soybean meal, fish meal, soy oil cake, and dried distillers' grains with solubles (DDGS).

21. The method of claim 17, wherein the one or more peroxyacid is peroxypropionic acid.

22. The method of claim 17, where the composition further comprises an acid selected from the group consisting of propionic acid, acetic acid, citric acid, and blends thereof.

23. The method of claim 17, wherein the composition further comprises a peroxide.

24. The method of claim 17, wherein the composition is a wet feed additive.

25. The method of claim 17, wherein the composition is a dry feed additive.

26. The method of claim 17, wherein the composition does not contain formaldehyde.

27. The method of claim 17, wherein the composition does not contain formic acid.

28. The method of claim 17, wherein the composition further comprises an organic peroxide.

29. The method of claim 17, wherein the composition further comprises a surfactant.

30. The method of claim 17, wherein the composition further comprises an emulsifier.

31. A method of controlling growth or spread of a spore-producing organism in animal feed or water, comprising adding to the feed or water a composition comprising one or more peroxyacid in an amount capable of reducing a number of the spore-producing organism in the feed or water.

32. The method of claim 31, wherein the spore-producing organism is mold or yeast.

33. The method of claim 31, wherein the one or more peroxyacid is peroxypropionic acid.

34. The method of claim 31, where the composition further comprises an acid selected from the group consisting of acetic acid, citric acid, propionic acid, and blends thereof.

35. The method of claim 31, wherein the composition is a wet feed additive.

36. The method of claim 31, wherein the composition is a dry feed additive.

37. The method of claim 31, wherein the composition does not contain formaldehyde.

38. A method of detoxifying mycotoxins in animal feed, comprising:
adding a composition comprising one or more peroxyacid to the animal feed in an amount effective to reduce an amount of mycotoxin in the animal feed.

39. The method of claim 38, wherein the one or more peroxyacid is peroxypropionic acid.

40. The method of claim 38, wherein the composition does not contain formaldehyde.

41. A method for controlling or reducing growth of a spore-producing organism in animal feed comprising:
mixing a first component that contains at least one peroxyacid and a second component that contains a phosphate buffer to form a composition;
applying the composition to the animal feed in an amount effective to reduce the growth of the spore-producing organism in the animal feed compared to an untreated animal feed;
wherein the pH of the first component is about 1 or less and the pH of the second component is about 12 to 13; and
wherein the composition does not contain formaldehyde.

42. The method of claim 41, wherein the first component and the second component are mixed at a ratio of about 9:1.

43. A kit for treating animal feed comprising:
a first component containing a peroxyacid concentrate;
a second component containing a phosphate buffer;
instructions for mixing the first component and the second component in order to form a composition that contains the peroxyacid in an amount effective to prevent growth of a spore-producing organism in the animal feed.

44. The kit of claim 43, wherein the first component contains peroxypropionic acid.

45. The kit of claim 43, wherein the spore-producing organism is a mold or yeast.
